(19) United States
(12) Patent Application Publication
(10) Pub. No.: US 2007/0083744 A1
(43) Pub. Date: Apr. 12, 2007

(54) Digital broadcast processing apparatus and boot loader upgrade method thereof

(75) Inventor: Dong-ryun Seok, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/518,223

(22) Filed: Sep. 11, 2006

(30) Foreign Application Priority Data
Oct. 10, 2005 (KR) 10-2005-0095155

(51) Int. Cl. G06F 15/177

(52) U.S. Cl. 713/1

(57) ABSTRACT

A digital broadcast processing apparatus and a boot loader upgrade method of the same are provided. The apparatus includes a first memory having a boot loader sector storing a boot loader and an application program sector storing an application program, and a second memory to which the boot loader and the application program are stored to execute the boot loader and the application program. The method includes determining whether a boot loader application program for upgrading a boot loader code is received; downloading the boot loader application program to the application program sector when the boot loader application program is present according to a result of the determination; backing up the downloaded boot loader application program to the second memory; and storing the boot loader code on the boot loader sector by executing the stored boot loader application program.

### CROSS-REFERENCE TO RELATED APPLICATIONS

This application claims priority from Korean Patent Application No. 10-2005-0095155, filed on Oct. 10, 2005, in the Korean Intellectual Property Office, the disclosure of which is incorporated herein by reference.

### BACKGROUND OF INVENTION

1. Field of Invention

Apparatuses and methods consistent with the present invention relate to a digital broadcast processing apparatus and a boot loader upgrade method of the same, and more particularly, to a digital broadcast processing apparatus capable of upgrading a boot loader without using a separate writer and a boot loader upgrade method thereof.

2. Description of the Related Art

When power is supplied to a digital broadcast processing apparatus, prior to receiving and the processing a broadcast signal, a system in the digital broadcast processing apparatus is initialized and the booting is performed to examine applications. Typically, software executing the booting is called a boot loader. The boot loader includes a boot loader code.

Typically, the boot loader is stored in a non-volatile storage device and then stored to a volatile storage device for the booting operation. In the case where the boot loader or the boot loader code stored in the non-volatile storage device is upgraded or changed, a new boot loader for upgrading is generally written in the non-volatile storage device using a read only memory (ROM) writer. Alternatively, the boot loader is upgraded using a separate device such as a debugger.

However, the above-mentioned upgrade method is unavailable if the digital broadcast processing apparatus is already on the market. Furthermore, changes of the boot loader which occur during the development phase of the digital broadcast processing apparatus, result in increased time and cost required to change the boot loader.

### SUMMARY OF THE INVENTION

The present invention provides a method of upgrading a boot loader while reducing load of the boot loader.

According to an aspect of the present invention, a boot loader upgrade method of a digital broadcast processing apparatus which comprises a first memory having a boot loader sector storing a boot loader and an application program sector storing an application program, and a second memory to which the boot loader and the application program are stored to execute the boot loader and the application program, the method comprising: determining whether a boot loader application program comprising a boot loader code to be used for the upgrading is received; downloading the boot loader application program to the application program sector when the boot loader application program is present; backing up the downloaded boot loader application program to the second memory; and storing the boot loader code on the boot loader sector by executing the stored boot loader application program.

The boot loader upgrade method may further comprise performing booting by use of the boot loader code stored on the boot loader sector.

The boot loader sector may comprise at least two boot loader storage areas, and a version of the stored boot loaders is marked on the boot loader storage areas. Further, the booting may be performed according to the boot loader stored on the boot loader storage area marked with a higher version of the boot loader.

According to another aspect of the present invention, there is provided a digital broadcast processing apparatus comprising: a first memory which includes a boot loader sector storing a boot loader and an application program sector storing an application program; a second memory to which the boot loader and the application program are stored to execute the boot loader and the application program; and a controller which downloads a boot loader application program to the application program sector when the boot loader application program for upgrading a boot loader code is received.

The controller may back up the downloaded boot loader application program to the second memory, and executes the backed-up boot loader application program. Further, the boot loader code may be stored on the boot loader sector when the boot loader application program is executed, thereby upgrading the boot loader.

The boot loader sector may include at least two boot loader storage areas, wherein the boot loader storage areas are marked with versions of stored boot loaders. Further, the booting may be performed according to a boot loader stored on the boot loader storage area marked with a higher version of the boot loader when the boot loader application program is aborted.

### BRIEF DESCRIPTION OF THE DRAWINGS

The above and/or other aspects of the prevent invention will become apparent and more readily appreciated from the following description of the exemplary embodiments, taken in conjunction with the accompany drawings, in which:

FIG. 1 is a block diagram of a digital broadcast processing apparatus according to an exemplary embodiment of the present invention; and

FIG. 2 is a flowchart outlining a boot loader upgrade method of the digital broadcast processing apparatus according to an exemplary embodiment of the present invention.

### DETAILED DESCRIPTION OF THE EXEMPLARY EMBODIMENTS OF THE INVENTION

Reference will now be made in detail to the exemplary embodiments of the present invention, examples of which are illustrated in the accompanying drawings, wherein like reference numerals refer to like elements throughout. The exemplary embodiments are described below so as to explain the present invention by referring to the figures.

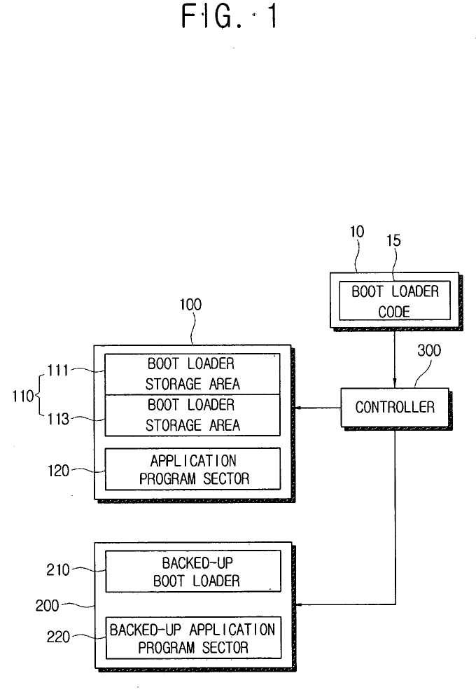

FIG. 1 is a block diagram of a digital broadcast processing apparatus according to an exemplary embodiment of the present invention. As shown in FIG. 1, the digital broadcast processing apparatus includes a first memory 100, a second memory 200, and a controller 300. The controller 300 executes diverse programs stored in the first memory 100 and the second memory 200.

The first memory 100 includes a boot loader sector 110 storing a boot loader, and an application program sector 120 storing an application program. The first memory 100 includes many sectors (not shown), to store various data for operating the digital broadcast processing apparatus.

The first memory 100 may be a non-volatile memory which stores mandatory data and programs for starting and operating the digital broadcast processing apparatus.

The boot loader sector 110 includes two boot loader storage areas 111 and 113. The boot loader storage areas 111 and 113 are marked with versions of the stored boot loaders. The version of the boot loader indicates the versions of the boot loaders currently stored in the boot loader storage areas 111 and 113. Thus, the boot loader version provides information relating to which boot loader stored in the boot loader storage area 111 or 113 has a higher version. The booting operation is carried out according to the boot loader stored in the boot loader storage area 111 or 113 which indicates a higher boot loader version.

In the case that execution of a boot loader application program is aborted or upgrade of the boot loader fails because the power supply to the digital broadcast processing apparatus stops, the booting is performed according to the boot loader having the higher version. The boot loaders in two boot loader storage areas 111 and 113 are upgraded in an alternating manner. For every upgrade, the version of the boot loader is also upgraded.

When the power is supplied to the digital broadcast processing apparatus, the boot loader examines and initializes diverse hardware to activate the system, and retrieves and prepares to execute a valid code by retrieving the application program. In the exemplary embodiment of the present invention, the boot loader code denotes a kind of program unit constituting the boot loader. In practice, the boot loader code denotes a portion having upgrade information of the boot loader when the boot loader is upgraded.

The boot loader is programmed not only to read and write programs but also to search for a program containing information relating to the upgrade among programs received from outside. To help understanding about the boot loader upgrade method of the digital broadcast processing apparatus, it should be noted that although the digital broadcast processing apparatus includes the controller 300, the boot loader is able to search, read, and write a program for itself.

The application program sector 120 stores diverse application programs required to operate the digital broadcast processing apparatus. The application program sector 120 further includes an area storing a new application program for the upgraded application program.

The boot loader and the boot loader code stored in the first memory 100 are stored to the second memory 200 to perform the booting operation.

The second memory 200 includes a boot loader sector 210 storing the stored boot loader, and an application program sector 220 storing the stored application program. Primarily, since most programs are executed after being stored in the second memory 200, the second memory 200 corresponds to a portion to operate the digital broadcast processing apparatus in practice.

The controller 300 determines whether a boot loader application program 10 that includes a boot loader code 15 for upgrading the boot loader is received, and upgrades the boot loader when the boot loader application program 10 is received according to a result of the determination. The boot loader application program 10, including the boot loader code 15, may be transmitted to the digital broadcast processing apparatus through an external storage device or the like using Universal Serial Bus (USB), or received in a form of broadcast data similar to reception of a digital broadcast signal. In this case, a manufacturer of the digital broadcast processing apparatus may create and transmit the boot loader application program 10 as firmware or the like software.

In the related art, when a new boot loader code needs to be upgraded, the boot loader code is written directly in the boot loader storage area. By contrast, in the exemplary embodiment of the present invention, the boot loader code 15 is inserted into the application program and then downloaded to the application program sector 120, rather than writing the boot loader code 15 directly in the boot loader storage area 111 or 113. That is, the boot loader code 15 to be upgraded is input to the digital broadcast processing apparatus in the form of the application program and upgraded by the execution of the boot loader application program 10. Since the upgrade, which has been achieved by hardware in the related art, is implemented by software according to an exemplary embodiment of the present invention, it is possible to reduce the cost and efforts required to upgrade the boot loader. The boot loader code 15 to be upgraded is included in the boot loader application program 10 as a data file in the form of a hexadecimal code.

The controller 300 downloads the boot loader application program 10 containing the boot loader code 15 to the application program sector 120 of the first memory 100, and stores the downloaded boot loader application program 10 to the application program sector 220 of the second memory 200.

As described above, as the boot loader has the ability to retrieve, read and write a program, the boot loader stores the boot loader application program 10 to the application program sector 220. The subsequent upgrade operations are fulfilled by the execution of the application program, to thereby diminish the role of the boot loader.

The subsequent upgrade operations are similar to the program upgrade method well known to one skilled in the art. It is to be understood that the descriptions as to the upgrade method of the present invention is not limited to a specific mechanism.

When the stored boot loader application program 10 is executed, the boot loader code 15 includes in the boot loader application program 10 is newly stored in the boot loader sector 110 of the first memory 100. The boot loader code 15 is upgraded and stored in one of the boot loader storage areas 111 and 113, which has the highest version. Next, the booting operation is performed by the upgraded boot loader code 15.

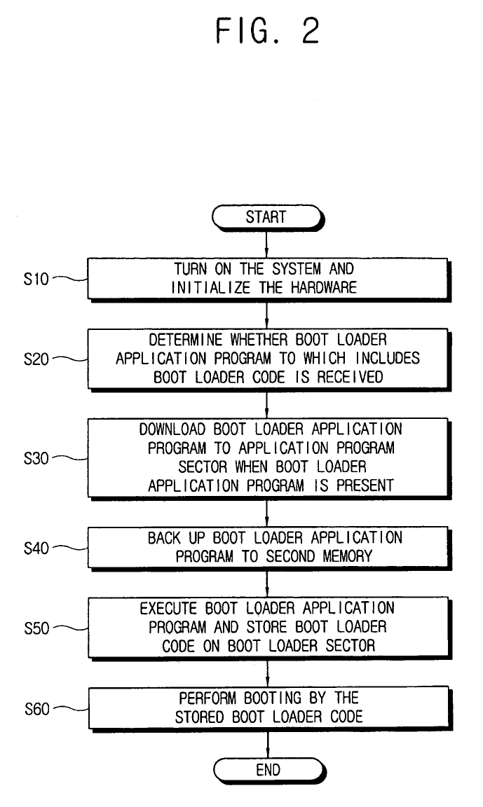

FIG. 2 is a flowchart outlining a boot loader upgrade method of the digital broadcast processing apparatus according to an exemplary embodiment of the present invention, to be set forth below.

First, when the power is applied to the digital broadcast processing apparatus, the system is turned on and the hardware is initialized by the boot loader (S10).

Next, a determination is made as to the reception or absence of the boot loader application program 10 that includes the boot loader code 15 is received (S20). When the boot loader application program 10 is received, the boot loader application program 10 is downloaded to the application program sector 120 of the first memory 100 under the control of the controller 300 (S30).

The boot loader application program 10 is stored from the first memory 100 to the application program sector 220 of the second memory 200 (S40). As the stored boot loader application program 10 is executed, the boot loader code 15 is stored in the boot loader sector 110 of the first memory 100 (S50).

When the boot loader code 15 is stored in the boot loader sector 110, the booting is carried out by the stored boot loader code 15 (S60).

Accordingly, the boot loader upgrade method can facilitate the upgrade of the boot loader without having to use a separate writer, and reduce the time and the cost required to upgrade the boot loader.

In view of the foregoing exemplary embodiments of the present invention can facilitate the upgrade of the boot loader while reducing the load of the boot loader.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

1. A boot loader upgrade method of a digital broadcast processing apparatus which comprises a first memory comprising a boot loader sector which stores a boot loader and an application program sector which stores an application program, and a second memory in which the boot loader and the application program are stored to execute the boot loader and the application program, the method comprising:
determining whether a boot loader application program is received, wherein the boot loader application program comprises a boot loader code which is used to upgrade the boot loader;
downloading the boot loader application program to the application program sector if it is determined that the boot loader application program is received;
storing the boot loader application program, which is downloaded to the application program sector, in the second memory; and
storing the boot loader code in the boot loader sector when executing the boot loader application program which is stored in the second memory.

2. The boot loader upgrade method according to claim 1, further comprising booting the digital broadcast processing apparatus using the boot loader code stored in the boot loader sector.

3. The boot loader upgrade method according to claim 2, wherein the boot loader sector comprises at least first and second boot loader storage areas.

4. The boot loader upgrade method according to claim 3, wherein the boot loader sector further comprises a version of the stored boot loaders is marked on the first and second boot loader storage areas.

5. The boot loader upgrade method according to claim 4, wherein the booting is performed according to the boot loader stored in the first and second boot loader storage area marked with a highest version of the boot loader.

6. A digital broadcasting processing apparatus comprising:
a first memory comprising a boot loader sector which stores a boot loader and an application program sector which stores an application program;
a second memory in which the boot loader and the application program are stored; and
a controller which downloads a boot loader application program to the application program sector if it is determined that the boot loader application program is received,
wherein the boot loader application program comprises a boot loader code which is used to upgrade the boot loader.

7. The digital broadcast processing apparatus according to claim 6, wherein the controller stores the downloaded boot loader application program to the second memory, and executes the boot loader application program stored in the second memory.

8. The digital broadcast processing apparatus according to claim 6, wherein the boot loader and the application program are stored in the second memory in order to execute the boot loader and the application program.

9. The digital broadcast processing apparatus according to claim 7, wherein the boot loader code is stored in the boot loader sector when the hoot loader application program is executed.

10. The digital broadcast processing apparatus according to claim 6, wherein the boot loader sector comprises at least first and second boot loader storage areas.

11. The digital broadcast processing apparatus according to claim 10, wherein the first and second boot loader storage areas are marked with versions of stored boot loaders.

12. The digital broadcast processing apparatus according to claim 11, wherein the controller performs booting according to the boot loader stored in the first and second boot loader storage area marked with a highest version of the boot loader.

13. A computer-readable recording medium having stored thereon a computer program, for performing a boot loader upgrade method of a digital broadcast processing apparatus which comprises a first memory comprising a boot loader sector which stores a boot loader and an application program sector which stores an application program, and a second memory in which the boot loader and the application program are stored to execute the boot loader and the application program, the method comprising:
determining whether a boot loader application program is received, wherein the boot loader application program comprises a boot loader code which is used to upgrade the boot loader;
downloading the boot loader application program to the application program sector if it is determined that the boot loader application program is received;
storing the boot loader application program, which is downloaded to the application program sector, in the second memory; and
storing the boot loader code in the boot loader sector when executing the boot loader application program which is stored in the second memory.

14. The boot loader upgrade method according to claim 1, wherein the boot loader determines whether the boot loader application program is received.

15. The digital broadcast processing apparatus according to claim 6, further comprising a controller which determines whether the boot loader application program is received.
